(19) United States
(12) Patent Application Publication
(10) Pub. No.: US 2014/0053110 A1
(43) Pub. Date: Feb. 20, 2014

(54) Methods for Arranging and Presenting Information According to A Strategic Organization Hierarchy

(71) Applicant: OrgSpan, Inc., Durham, NC (US)

(72) Inventors: Donald Brown, Indianapolis, IN (US); Jeffrey Swartz, Cary, NC (US)

(73) Assignee: ORGSPAN, INC., Durham, NC (US)

(21) Appl. No.: 13/971,470

(22) Filed: Aug. 20, 2013

Related U.S. Application Data
(60) Provisional application No. 61/684,843, filed on Aug. 20, 2012.

(51) Int. Cl. G06F 3/0481

(52) U.S. Cl. CPC G06F 3/0481
USPC 715/853

(57) ABSTRACT

Methods for arranging and presenting information according to a strategic organization hierarchy are described. A method for arranging and presenting information according to a strategic organization hierarchy includes the steps of receiving organization information comprising a plurality of organization components, arranging the organization information into an organization hierarchy, and displaying at least a portion of the organization hierarchy in a graphical user interface.

### RELATED APPLICATIONS

This application claims priority from U.S. Provisional Application No. 61/684,843, filed 20 Aug. 2012 and entitled “METHODS FOR ARRANGING AND PRESENTING INFORMATION ACCORDING TO A STRATEGIC ORGANIZATION HIERARCHY”, the contents of which are incorporated herein as if set forth in full.

### FIELD

This invention relates generally to enterprise software and in particular to methods for arranging and presenting information according to a strategic organization hierarchy.

### BACKGROUND

While an organization member loses focus of an organization's objectives or how their work contributes to the goals of the business, their productivity suffers and their job satisfaction declines. Even in small businesses with only a few dozen employees, business objectives may evolve while project trajectories are left unchanged, increasing the gap between an employee's activities and the goals of the business. Furthermore, if employees are overwhelmed by their day-to-day responsibilities, they may ignore or fail to see better alternatives for achieving those business objectives.

Trying to solve these problems by sifting through personnel, organizational, and strategic information in conventional systems may be difficult, however. To begin with, traditional methods for team building and project planning are inefficient, and may not fully utilize organization information for building an effective team. During the project, project management tools may not use the best information for tracking projects and informing managers and team members about their progress.

Thus there is a need for methods and systems to arrange and present information according to a strategic organization hierarchy.

### SUMMARY

Methods are described for arranging and presenting information according to a strategic organization hierarchy. In one embodiment, a method for arranging and presenting information according to a strategic organization hierarchy comprises receiving organization information, which may be associated with an organization. Next, the organization information is arranged into an organization hierarchy which may comprise a plurality of hierarchical levels. At least a portion of the organization hierarchy may be displayed in a graphical user interface.

In another embodiment, executable instructions are stored on a non-transitory computer-readable storage medium, the executable instructions that, when executed by a processor cause the processor to perform operations comprising receiving organization information, arranging the organization information into an organization hierarchy, and displaying at least a portion of the organization hierarchy in a graphical user interface.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate embodiments of the present invention and, together with the description, serve to explain the principles of the invention and to enable a person skilled in the pertinent art to make and use the invention.

FIG. 1 is a flow chart illustrating a first method for arranging and presenting information according to a strategic organization hierarchy.

FIG. 2 is a flow chart illustrating a second method for arranging and presenting information according to a strategic organization hierarchy.

FIG. 3 is a flow chart illustrating a third method for arranging and presenting information according to a strategic organization hierarchy.

FIG. 4 is a flow chart illustrating a fourth method for arranging and presenting information according to a strategic organization hierarchy.

FIG. 5 is a block diagram illustrating a system for arranging and presenting information according to a strategic organization hierarchy.

FIGS. 6-10 are screenshots of an organization hierarchy application executing as an iPad application.

FIG. 11 is a screenshot of an organization hierarchy application executing as an Android application.

FIGS. 12-14 are screenshots of an organization hierarchy application executing as a web application.

### DETAILED DESCRIPTION

Methods and systems are described for arranging and presenting information according to a strategic organization hierarchy. Embodiments advantageously allow users to quickly and easily view and navigate an organizational hierarchy. Social media information may be linked with an organization hierarchy to facilitate communication and boost productivity. Users may easily monitor their own progress, or the progress of their direct reports, subscribe to components of an organization hierarchy to automatically receive updates, and receive reminders for updating their status and/or progress.

In one exemplary embodiment, organization information associated with a business is received by a server from an Active Directory database. An organization hierarchy comprising a linked arrangement of organization components is then generated. Each organization component may comprise one or more hierarchical links and be associated with an organization hierarchy level. Examples of organization components include an individual organization member (i.e. employee, team member, volunteer, etc.), organizational units (e.g. divisions, departments, team, etc.), and/or a planning component (e.g. goal, objective, strategy, plan, action, etc.). Some or all of the organization hierarchy is presented in a graphical user interface through a web application or native application interface such as an iOS iPad application.

Through the graphical presentation of the organization hierarchy, users may easily view, navigate, and update the organization hierarchy from multiple perspectives, including broad overviews of the organization, its arrangement, and its goals, to more detailed and focused views of individual members and specific actions. The arrangement of the organization hierarchy may permit users to monitor and/or subscribe to different levels of the organization hierarchy (e.g. different levels of a department, project, or objective), with updates automatically pushed to subscribers. Access permissions may be set according to users, organization units, and/or strategic items, such that the ability to view and/or edit organization information within the hierarchy may be based on a user's permission level. Reminders may be automatically sent to organization members to encourage users to update their status and progress, which may result in more timely and accurate information in the organization hierarchy.

### Organization Hierarchy

Methods for arranging and presenting information according to a strategic organization hierarchy may generate an organization hierarchy. Information about an organization, such as a business, government agency, educational institution, or not-for-profit organization, may be collected for generating an organization hierarchy. The organization information collected and arranged may comprise information associated with organization personnel (e.g. information about some or all of the organization members), organization goals (e.g. information about some or all of the organization's objectives), and organization activity (e.g. meetings, work activity, etc.).

The organization hierarchy may reflect the arrangement of an organization, e.g. by divisions, departments, or teams. The organization hierarchy may further reflect formal and/or informal relationships between organization members, such as personal assistants and direct reports.

An organization hierarchy may comprise a linked arrangement of organization components. An organization component may comprise an individual organization member (i.e. employee, team member, volunteer, etc.), an organizational unit (e.g. divisions, departments, team, etc.), a planning component (e.g. goal, objective, strategy, plan, action, etc.), and/or an activity (e.g. meeting, document editing, race, etc.).

Each organization component may comprise one or more hierarchical links. An organization member may comprise a hierarchical link to a superior member, or antecedent member. An organization member may also comprise one or more hierarchical links to a subordinate member, or descendant member. A plurality of hierarchy levels may be generated in the organization hierarchy based on the hierarchical links of each organization component.

Arrangement of organization information into an organization hierarchy may facilitate reporting and tracking of organization activities and goals. Organization components and/or hierarchical levels may be viewed, navigated, and edited. Organization components may be monitored or tracking by navigating the organization hierarchy to view particular component details, or by manually or automatically subscribing to particular organization components.

Embodiments allow for basic and extended searching of an organization hierarchy. Users may search an organization hierarchy for particular components, such as by a partial name, or by other elements, such as skills or target dates. The organization hierarchy may include a search interface that may facilitate searching the entire organization hierarchy, or searching specific aspects of the organization hierarchy, such as by skill or project.

### Project, Goal, and Activity Tracking

Methods for arranging and presenting information according to a strategic organization hierarchy may generate an organization hierarchy including a plurality of strategic planning components, such as goals, objectives, strategies, plans, actions, and projects, and display the organization hierarchy in a graphical user interface. Embodiments may advantageously allow top-down definition of objectives and bottom-up tracking of activity through the generation and updating of an organization hierarchy.

Users may be able to specify planning components, such as objectives, at any level of an organization hierarchy. A planning component may comprise a name, description, priority, and a target date. Additionally, planning components may comprise other information such as a completion date, progress notes, and/or a completion percentage. In one embodiment a proposed planning component comprises a poll or voting element. Users may be able to vote on a proposed planning component, view poll results, and/or post messages about the planning component.

A planning component may be associated with one or more other organization components. For example, a planning component may include information such as an originating organization member (e.g. author), associated organization member(s) and/or associated organization units (e.g. assignees). Newly created or edited objectives may be automatically associated with superior components, such as pre-existing objectives at ancestor levels of the organization hierarchy.

In one embodiment, a planning component comprises a project. A project may comprise a name, description, target date, priority, owner, members (e.g. participants), completion percentage, and estimated completion date. Some information associated with a project may comprise links to other organization components, such as objectives, actions, and members (e.g. project owner, project participants). A project may also be linked to other static or dynamic content, such as an FAQ, an editable wiki information page, and/or linked as a Jira project entry.

Users may be able to view and maintain organization components from within an organization hierarchy application. For example, a user may access a personal home page to view and maintain a to-do list comprising all of that user's tasks. Managers may access a team or project view to review status reports. Planning components may be quickly and easily viewed and updated within an organization hierarchy application. Graphical user interface components, such as a slider, date selection, or additive and subtractive buttons, may be used to adjust elements of a planning component, such as a start date, percentage completion, expected completion date, and/or actual delivery date.

Users may be able to quickly and easily navigate components of an organization hierarchy. In one embodiment, users may be able to view planning components based on a specified time-scale (e.g. five years, one year, one month, one week, etc.) and/or time-frame (next fiscal year, next quarter, last month, etc.). Graphical user interface components, such as a slider, or zoom-in and zoom-out buttons, may be used to adjust the time horizon and/or starting time point of a planning component view to easily see planning components associated with longer or shorter-term horizons. As an example, a user may adjust a timescale slider to view objectives within the next five years, this year, or this quarter. Users may be able to view both historical and forward-looking time frames. When a user views past objectives, they may be able to view how well the objectives within that historical time frame were accomplished.

Other aspects of an organization hierarchy may be presented to a user independent of a specified time frame. For example, a user may access a to-do list, or task list, showing all incomplete and/or completed tasks. A task list may be organized by priority, by completion percentage, by target date, or according to some other criteria.

Planning components may be manually or automatically updated. In one embodiment, users may be able to manually update a planning component, such as by entering a note regarding a specific objective, or specifying a completion percentage of a task. Updates to a planning component associated with an organization member may be automatically added to a status report generated for or by an organization member.

In another embodiment, a planning component may be automatically updated. As one example, an objective may comprise a plurality of tasks. The percentage completion of the objective may be automatically updated as the percentage completion of associated tasks changes. The percentage completion of a superior planning component, such as a goal or objective, may comprise a weighted average of the completion percentage of subordinate planning components, or in one alternative, may comprise the lowest completion percentage of any singular subordinate planning component. As the lowest completion percentage of a subordinate planning component is increased, the completion percentage of the objective is changed automatically.

Views of an organization hierarchy and planning components of an organization hierarchy within a graphical user interface may show multiple levels of the organization hierarchy, or multiple layers, within the same view. Users may be able to see a planning component and one or more subordinate planning components in the same view, such as in a card view or radial view showing a plurality of hierarchical levels. Such views with multiple planning components may show an overall percentage completion and/or completion percentages for each planning component. Details or specific elements associated with one or more planning components may be shown in the same view, and/or may be accessed by selecting, clicking, or mousing-over a planning component. For example, a user may quickly view a completion percentage of a planning component through a mouse-over input of the associated planning component. Details or specific elements may be represented in a variety of ways, such as text (e.g. “95% complete) and/or graphically, such as green highlighting for high completion percentages and red highlighting for low completion percentages.

Embodiments may allow users to easily monitor, track, and/or encourage progress on a certain task. Notifications, such as reminders and/or reports, may be automatically generated based on a status of a planning component. For example, an overdue status report or task, or a deficient completion percentage may cause a notification to be generated. A notification may comprise an email, text message, automated phone call, or some other type of electronic communication. A notification may also be generated within an application, such as an organization hierarchy application, with audio, visual, and/or haptic cues for alerting a user. A notification may be sent or transmitted to an organization member (or members) associated with a planning component, such as the member assigned to a task and/or a supervisor of that member.

Employees may be prompted to create status reports and update their progress, and managers may be alerted when such updates are not completed. Reminders may be automatically sent to one or more members associated with a planning component to update their status and/or progress. Reminders may be based on predetermined intervals and per organization unit or planning component, for example, weekly for development status reports, monthly for marketing status reports, etc.

Embodiments may provide quick and easy methods for viewing member performance. In a graphical display of an organization hierarchy, a superior may access a view showing various details about their team, such as their performance level, active projects, completed projects, etc. Thus managers may easily see how well different employees perform, such as in how timely they achieve their objectives. Status reports may be arranged for easy review, such as by date, time interval, or organizational unit. Thus managers may easily view collections of status reports for a given interval.

Access to aspects of an organization hierarchy, such as particular planning components, may be determined based on permission levels. Granular access rights may be provided for individual planning components making it easy for users to determine who can see and/or modify each component. In one embodiment, a default access scheme restricts creation and/or modification of planning components, such as group objectives, to managers or supervisors.

An organization hierarchy may be accessed and/or updated based on a permission level of a user. Employees with the appropriate rights may be able to create organization components such as projects that are associated with their hierarchical level and/or subordinate hierarchical levels.

Superiors may be able to create planning components, such as tasks or projects, and assign them to organization units, groups, or individual members. In one embodiment, superiors are limited to creating and assigning planning components to organization members only in their sub-hierarchy (i.e. subordinate members). For example, managers may be able to add to-do items only for their own subordinates. In another embodiment, members may create and/or assign planning components across an organization, both for their subordinates, superiors, and unrelated members. Mid-level members, such as a manager, may be automatically notified when their supervisor, such as a department head or President, creates and/or assigns a task to one of their subordinates. For example, when a C.E.O. creates a task for a Public Relations manager, the Vice President of Marketing may be notified.

Planning components may also be subject to approval. For example, an employee may create a new task assigned to themself to accomplish in a particular time period (e.g. next quarter, next month, etc.). That employee's manager may receive a notification upon creation of the new task, and be able to approve or disapprove of the task. Disapproved tasks may be discarded from organization hierarchy, while approved tasks may be included in an updated organization hierarchy.

Users may utilize an organization hierarchy application to track activities and/or create events. In embodiments users may be able to quickly and easily set up project teams and manage meetings. An organization hierarchy application may include a link to a scheduling program, such as Microsoft Outlook, for easily creating a meeting including information currently being viewed in the organization hierarchy application, such as a particular organization member or department and/or an action or project. For example, a user may view a project in an organization hierarchy application. The project may include a link to create a meeting that will automatically invite each member of that project. A meeting may comprise a date, time, organizer, subject, description, agenda, location, result, participants, and/or a list of objectives or to-dos. Creation and/or management of a meeting may be based on permission level, and may be limited to a meeting manager or creator, for example.

Information about activities and events, such as meetings, may be received and incorporated into the organization hierarchy. For example, an organization hierarchy program may receive one or more sets of notes related to a project meeting. The organization hierarchy application may parse the notes and update the appropriate organization components, such as members who attended the event, actions that were discussed, tasks that were created, and progress that was reported.

### Example Methods

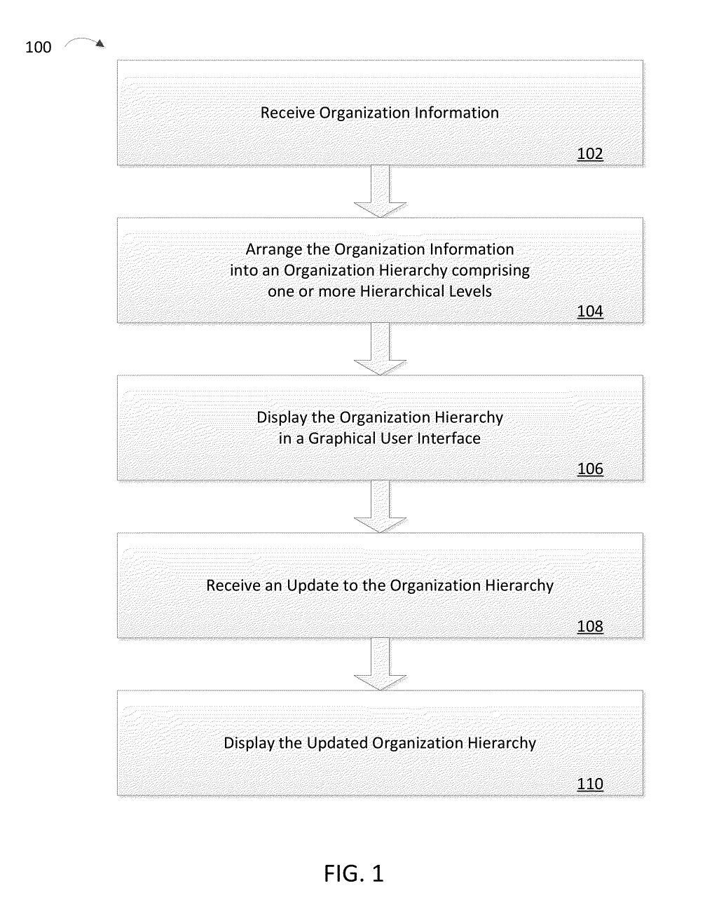

FIG. 1 is a flow chart illustrating a first method 100 for arranging and presenting information according to a strategic organization hierarchy. In the first step 102, organization information is received. A computer system, such as an integrated services server, may receive the organization information over a local or remote network connection. The organization information may comprise information associated with an organization such as a business (e.g. a corporation, a professional partnership, or other concern), service club, charitable organization, professional organization, team, or some other group of one or more individuals. The organization information may comprise information associated with one or more organization components, such as individual organization members, organizational units, and/or planning components.

Organization information may be received locally or remotely, and may be received automatically or manually. Organization information may be received from an organization data store, such as a database and/or directory service. Examples of directory services include, without limitation, Active Directory, eDirectory, Red Hat Directory Server, Apache Directory Server, OpenDS, and OpenLDAP. Other organization data stores may comprise Microsoft Outlook, Microsoft Lync, or Microsoft Exchange Server. Organization information may be received from one or more discrete sources. In one example, a large organization utilizes multiple Active Directory databases for tracking various objects such as security principles (e.g. users or user accounts) and resources (e.g. printers). Some or all of the information about the security principles and resources stored by the multiple Active Directory databases is received by a server, such as an integrated services server. Embodiments may be scalable from small organizations with tens of employees, a few organizational units, and a limited number of projects to large organizations with one million or more members, multiple organizational units and many different goals and activities.

Organization information may be received from a variety of sources, and via a variety of provocations. Organization information may be received through push delivery initiated by the sender, or pull delivery initiated by the server itself. Organization information may be received locally, for example, from local sensors on a device. For example, a GPS sensor on a device may automatically detect the location of an organization member. As another example information may be received locally from a human interface device, such as a touch screen or keyboard.

Organization information may also be received via manual data entry. Manual data entry may comprise data entry for particular fields of a component, such as correcting a name, or adding an email address. Organization information may be received through tabular entry of information, which may facilitate rapid setup of an organization hierarchy.

In an exemplary embodiment, organization information received from a directory may only be partially complete, or may be inaccurate or outdated. For example, in a directory database some employee records may not include a superior employee (e.g. boss, manager, supervisor, etc.). Or, an employee record may include outdated information, such as a subordinate member who no longer belongs to the organization. Such incomplete and/or inaccurate information may be supplemented, corrected, and/or updated through manual entry of organization information.

Organization information may comprise information associated with one or more organization components, and may comprise hierarchical information for each organization component. In one embodiment, organization information comprises information about one or more organization members. Hierarchical information for an organization member may comprise one or more superiors and/or one or more subordinates of the organization member. A superior (sometimes referred to as superordinates) may comprise an organization member having authority over that organization member, such as a manager, supervisor, director, boss, or team leader. A subordinate may comprise another organization member that the current organization member has authority over, such as a direct report, administrative assistant, or team member.

Organization information may comprise other types of information about an organization component, such as directory-type information, social media information, personal information, professional information, personnel or human resources information, social information, and/or strategic information. Directory-type information may include the name, title, and/or department for one or more members or the organization. Social media information may comprise a status, email address, instant message id, fax number, and/or telephone number of a member of an organization.

Personal information may comprise an image of a member (e.g. a head shot, security picture, personal icon, and/or candid picture), information about an organization's member's family (e.g. children, spouse), and other types of personal information such as hobbies. Professional information may comprise an organization member's education (e.g. degrees, colleges, universities, etc.), skills, certification, experience, and/or recommendations. Personnel or Human Resources type information may comprise a hiring date, current salary, salary history, promotion history, promotion track, production rating, and/or efficiency rating of an organization member.

Organization information may comprise information about other components of an organization, such as information about an organizational unit of the organization. Organizational unit information may comprise division information, department information, or team information. Examples of organizational unit information include a median salary of a department, the average production rating of a team, or most common skills and certifications of a group.

Organization information may also comprise strategic information, such as one or more goals, objectives, strategies, plans, or actions. For example, organization information may comprise one or more goals for the entire organization, for specific organizational units, and/or for individual members of the organization. As another example, organization information may comprise discrete tasks, action-items, or to-do items for members of an organization. As another example, organization information may comprise information concerning one or more projects, including staffed members, objectives, progress, and status reports.

Organization information may comprise information associated with the activities, work behavior, and/or accomplishments of an organization component. Such information may be actively tracked and stored, or in one alternative, be inferred. In an embodiment, organization information comprises activity tracking information, such as commonly accessed documents and applications and meeting information.

After the organization information is received in step 102, the organization information is arranged into an organization hierarchy in step 104. An organization hierarchy may comprise one or more hierarchical levels populated by a plurality of linked hierarchical organization components. Examples of organization components include, but are not limited to, individual employees, business units (e.g. divisions, departments, and teams), and/or strategic information (e.g. goals, objectives, strategies, plans, and actions). Each organization component may comprise one or more links to other organization components.

An organization component may comprise a link to a higher or superior organization component, and/or a link to a lower or inferior organization component. In one embodiment an organization component comprises an employee. Component information for an employee may comprise a link to that employee's superior (i.e. a person in a higher hierarchical level) and a link to one or more subordinates (i.e. a person in a lower hierarchical level). Some organization members, such as members at the top or bottom of an organization hierarchy, may only comprise links in one direction of the organization hierarchy. Other organization members, such as intermediate organization members, may comprise links in both directions of an organization hierarchy (i.e. an upper direction and a lower direction).

An organization hierarchy may include both formal and informal relationships between organization components. One example of an informal relationship that may be included in an organization hierarchy is a dotted line relationship. Such dotted line relationships may include members that work on the same project or team, or a member that has informal or loosely defined authority over another member.

An organization hierarchy may be arranged with one or more hierarchical levels. In one embodiment, each organization information components may be associated with a hierarchical level. Organization components that are linked to a single superior component may be associated with the same hierarchical level. For example, each employee that shares the same supervisor may be associated with the same hierarchical level. Alternatively, some components that share a common superior may not be associated with the same hierarchical level. For example, one or more department heads that directly report to a Chief Executive Officer (C.E.O.) may not share the same hierarchical level as a personal assistant that also directly reports to the C.E.O.

By arranging organization information into an organization hierarchy, organizational units may be quickly and easily created through an automated process, without the need for manual data entry of each member of an organization. Furthermore, embodiments may facilitate creation of organizational units through a graphical user interface, such as described below.

In an embodiment, an integrated services server may gather organization information from an Active Directory database. Pulling information from an Active Directory database already in use by an organization may facilitate the quick and easy creation of an organization hierarchy using information already collected and stored by an organization. An Active Directory database may include information such as member records, associated with some or all of the members of an organization. Each member record in a directory database may include a name field and a superior field. An integrated services server may receive the plurality of member records and automatically generate an organization hierarchy comprising a plurality of hierarchical levels based at least in part on the superior field.

An organization, and/or some or all of the members of an organization, may be structured as an organizational unit. Examples of an organizational unit include, but are not limited to, a division, a department, or a team. An organizational unit may comprise two or more levels. Organization members of each organizational unit may be ranked, assigned, and/or associated with a level of the organizational unit. In one embodiment, an organization hierarchy may reflect relationships within an organizational unit, such as relationships between members of the same hierarchical level or relationships between members of different hierarchical levels of the organization unit. As examples, an organization hierarchy may reflect dotted line responsibilities, manager(s), and/or direct reports of a member of an organization. Additionally, or as an alternative, an organization hierarchy may reflect relationships across two or more organizational units.

In an example, an organization comprises a business including an engineering department and a marketing department. Organization information about members of the engineering department and marketing department may be received and arranged into an organization hierarchy. The organization hierarchy may reflect relationships within each department, such as direct reporting relationships of engineers with their managers, relationships between assistants and managers, or the relationships between various managers with the engineering department head. The organization hierarchy may further reflect the relationships of the department heads with other department heads, other departments, and/or with a higher organization level such as a board of directors.

Within an organizational unit, each member of a hierarchical level may have a hierarchical relationship with a member belonging to a higher, or superior hierarchical level. For example, an associate in an organization such as a law firm may belong to a first hierarchical level and have a subordinate hierarchical relationship with a junior partner belonging to a second, higher hierarchical level.

One or more members at the highest hierarchical level of the organization, such as a chief executive officer (C.E.O.), president, or director, may not have any superior hierarchical relationships. For example, a C.E.O. may not report to anyone in the organizational hierarchy, and therefore have no superior hierarchical relationship. Such a high-ranking member may have a plurality of hierarchical levels below them.

On the opposite side of the organization hierarchy, one or more members at the lowest hierarchical level of an organization, such as support personnel, may not have any subordinate hierarchical relationships. For example, a personal assistant may have no one report to him, but may support one or more organization members in his superior hierarchical level. Such a low ranking member may have a plurality of hierarchical levels above them.

Between the top hierarchical level and the bottom hierarchical level, organization members may have both superior and subordinate hierarchical relationships. For example, a director may have a subordinate hierarchical relationship with the C.E.O., and at the same time have a plurality of superior hierarchical relationships with team leads.

An organization member may have one or more hierarchical relationships with members in superior and/or subordinate hierarchical levels. As one example, a manager may supervise a plurality of employees, sometimes called “direct reports.” An organization member may have hierarchical relationships across a plurality of hierarchical levels. For example, an administrative assistant associated with a first hierarchical level may support a junior associate associated with a second hierarchical level as well as support a junior partner on a third hierarchical level. Thus, some hierarchical relationships may span multiple hierarchical levels.

Some organization members may only have one superior hierarchical relationship, for example, a member who reports to only one manager. Other organization members may be associated with more than one superior member. For example, a member may be considered to be subordinate to both their manager and to their office manager. An advantage of methods for viewing and navigating organization hierarchy is the generation of a visual model that illustrates these complex relationships across an organization in a straightforward yet intuitive interface.

In one example, an organization comprises a business corporation. In the corporation, the highest, or top, hierarchical level comprises a chief executive officer, i.e. C.E.O. Other top-level members may comprise a director of a government agency, or a captain of a team. The top hierarchical level may include only one member of the organization, or alternatively may include a plurality of members, such as an executive committee or board of directors.

In the exemplary corporation, the second highest hierarchical level (i.e. the hierarchical level subordinate to the top hierarchical level) comprises a management team including a president, a chief operations officer (C.O.O.), a chief technology officer (C.T.O.), and a chief finance officer (C.F.O.). The third highest hierarchical level comprises one or more members subordinate to each respective member of the upper hierarchical level. For example, an accounting manager may belong to the third highest hierarchical level, and report to the C.F.O. A research and development manager may also belong to the third highest hierarchical level, and report to the C.T.O. An administrative assistant may report to the president, and also belong to the third highest hierarchical level.

In another exemplary embodiment, an organization hierarchy comprises a hierarchy of organization planning components comprising goals, objectives, strategies, plans, and actions (collectively “GOSPA” components). One or more goals may be arranged at the top of the organization hierarchy. A goal may comprise a general result that an organization seeks to achieve or accomplish. The next highest hierarchical level may comprise one or more objectives. An objective may be a measurable and/or quantifiable deliverable or achievement that may be delivered, accomplished, or achieved within a specified time frame. The next hierarchical level may comprise one or more strategies. A strategy may comprise a method for achieving an objective. A strategy may not have a specific deliverable or time frame, but may describe how to go about achieving an objective. The next hierarchical level may comprise one or more plans. A plan may comprise a scheme or method of acting, doing, working, etc. A plan may comprise a specific element of a strategy, and may have a “short-term time frame”, or a time-frame measured in days, weeks, or a month. The lowest hierarchical level in an organization hierarchy comprising GOSPA components may comprise one or more actions. An action may comprise an individual task that may be assigned to a single organization member. Some organizations may utilize different planning components. For example, an organization hierarchy may comprise goals, objectives, and actions.

Different types of organization components may be linked together, or associated together in an organization hierarchy. Planning components such as actions may be associated with member components such as individual employees, while goals may be associated with members at the highest hierarchical level. Intermediate planning components may be associated with members at intermediate hierarchical levels.

Users may be able to define subclasses of organizational units and/or organization members to easily build and access custom information. In one embodiment, an organization hierarchy may comprise one or more customized elements. Organization members, hierarchical levels, and/or organizational units may comprise elements custom or unique to that component or group. As one example, organization information associated with members in a development or engineering department may include a “computer language” element, while members in a finance or human resources department may not include the “computer language” element. As such, the definition of customized fields may be associated with needs and/or capabilities unique to that group or individual.

Next, in step 106, the organization hierarchy is displayed in a graphical user interface. An organization hierarchy application, such as an organization hierarchy viewer, may display an organization hierarchy. Users may access, view, navigate, zoom, and edit an organization hierarchy through an individualized home page, such as a home view. As a user browses an organization hierarchy, a user may subscribe to different levels of the hierarchy and/or different components of the hierarchy, and have updates automatically pushed to the user. Users may be able to monitor an organization hierarchy, such as the progress of planning components in a variety of top-level and detailed views. Further, users may be able to drill down (or zoom in) from a top-level view, that may show a plurality of components, into detailed views of individual components.

In one embodiment, an application such as an organization hierarchy application displays one or more perspectives of a data set in the form of an organization hierarchy. A home view may be associated with a personal perspective of the organization hierarchy, and may serve as an employee's primary electronic work interface. A home view may be customized according to the preferences of an individual employee, or in one alternative, according to a template applied to some or all members of an organization. In one aspect, an individualized home view may display some or all of the organization hierarchy, such as a prioritized to-do list view for that organization member, a list of recent contacts or activities, and/or a list of favorite contacts or documents.

The display of the organization hierarchy may be based at least in part on a permission level of a user. Different views of individual organization components, groups of components, entire hierarchical levels, and/or entire organizational units may be limited to certain permission levels. In one embodiment, a superior may be able to access different views of the organization hierarchy than a subordinate. By customizing permission levels to individual members, groups, or organization units, the display of the organization hierarchy may be customized. The presentation of an organization hierarchy may also be customized according to a template. A template, or set of templates, may define how the organization hierarchy is presented to individual members, or groups of members such as department. As an example, a departmental template for a human resources department may hide certain fields, such as computer languages, within the organization hierarchy application. Meanwhile, a departmental template for an engineering department may hide other fields, such as hiring date or salary.

Through customized templates and/or permission-level based views of an organization hierarchy, managers may be able to easily monitor the activities of their direct reports. As an example, a supervisor may be presented with specific views of the organization hierarchy they supervise, such as a productivity view or an activity view. Based on permission levels, such views may only be accessible by the supervisor alone, or by the supervisor and the supervisor's superiors, but not accessible by the supervisor's subordinates.

An organization hierarchy may be displayed via a software application in a graphical user interface. The organization hierarchy may be presented in a native application, such as an iOS app, an Android application, and/or a Windows Phone application. The organization hierarchy may also be presented as web application, accessible through an internet web browser such as Chrome, Firefox, Safari, or Internet Explorer. In one exemplary embodiment, a software application, such as an Apple iOS iPad app, generates a graphical user interface for arranging and presenting information according to a strategic organization hierarchy of a corporation with multiple hierarchical levels and hundreds of employees.

An organization hierarchy application may provide complementary functionality to displaying an organization hierarchy. For example, some or all of an organization hierarchy may be printed out or exported. Aspects of an organization hierarchy, such as cards associated with individual members, or GOSPA planning units, may be sent to an external program, such as a contact manager, calendar, or email program.

In one embodiment, an organization hierarchy application may include message board and/or blogging functionality. Users may be able to create posts (e.g. forum posts, blog posts, stickies, etc.) on an organization component such as a project or department. Access to such functionality may be controlled through a permission list, with the ability to create, view, and/or edit posts limited to certain organization members. For example each member within a department may be able to view and edit posts associated with a department project, while members outside of the department may only be able to view such posts.

An advantage of embodiments of the invention is that information related to the structure and members of an organization can be collected, arranged, and presented such that users may quickly and easily view and navigate an organization hierarchy. Hierarchical relationships such managers, direct reports, and dotted lines may be displayed. Embodiments may allow users to quickly and easily view and navigate the organization hierarchy, zoom in for more detail, and zoom out for a broader overview. In an example, an organization hierarchy may be displayed on a mobile device, with touch gestures such as pinch and spread used to navigate the organization hierarchy.

The organization hierarchy may be presented in a graphical user interface in a variety of manners. In one embodiment, an organization hierarchy is depicted in a graphical user interface as one or more scrolling carousels. In another embodiment, an organization hierarchy is depicted in a graphical user interface as one or more scrolling ribbons.

An organization hierarchy may comprise a plurality of organization components. An organization component may be represented in the graphical user interface as a card, (sometimes referred to as a profile). In one embodiment, a card may be generated for each organization component in an organization hierarchy. In another embodiment, some organization components may be hidden in an organization hierarchy, and not have an associated card. For example, a card may be generated for each full-time or salaried business employee, while a card may not be generated for temporary employees (e.g. “temps” or contract employees) or for independent contractors.

A card representing an organization component and displayed in the graphical user interface may display one or more details of the organization component. A card representing an organization member may show a name and title of the organization member, and/or additional information, such as experience, active projects, and social media information of the organization member. A card representing an organizational unit such as a department may show a name (e.g. Marketing, Finance, Engineering, etc.) and type (e.g. “Team”, “Department”, “Division”, etc.) of the organizational unit.

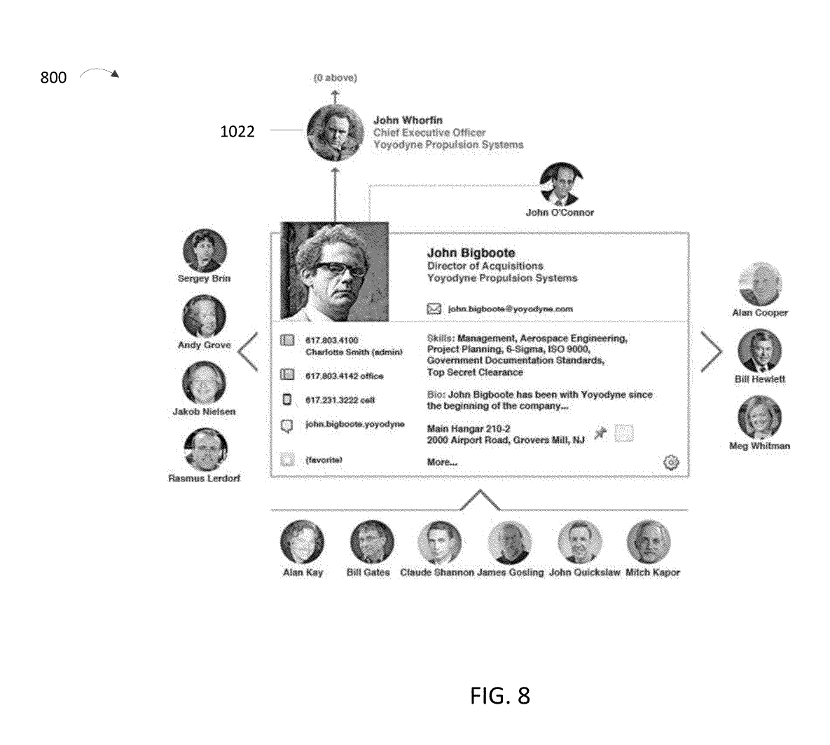

In one embodiment illustrated in FIG. 8 and further described below, a card may be displayed by an organization hierarchy application. As shown in FIG. 8, a card may be associated with an organization member, and may comprise a picture, name, title, department, email address, assistant information, office phone number, cellular phone number, instant message id, skills, biography, and office location of an organization member. In other embodiments, a card associated with an organization component, such as an organization member or planning component, may show other information.

In an embodiment, organization information including organization components is arranged into an organization hierarchy including a plurality of hierarchical levels, which is then displayed in a graphical user interface. A card associated with an organization component may be selected and prominently displayed in the graphical user interface, referred to as an active card.

The initial active card may be selected based on a variety of criteria. The selection of the active card may be based on the current user. For example, the initial active card may correspond to the current user, to a current project that the user is working on, or to the last person contacted by a user, or the last card viewed by a user. Other selections of the initial active card may comprise the user's superior (e.g. boss, manager, supervisor, etc.), or one of the user's subordinates. Alternatively, the selection of the active card may be based on other criteria, such as a global or departmental setting specified by a system administrator. For example, a system administrator may specify that the initial active profile may always be the head of the organization, a leader of the user's team, or the user.

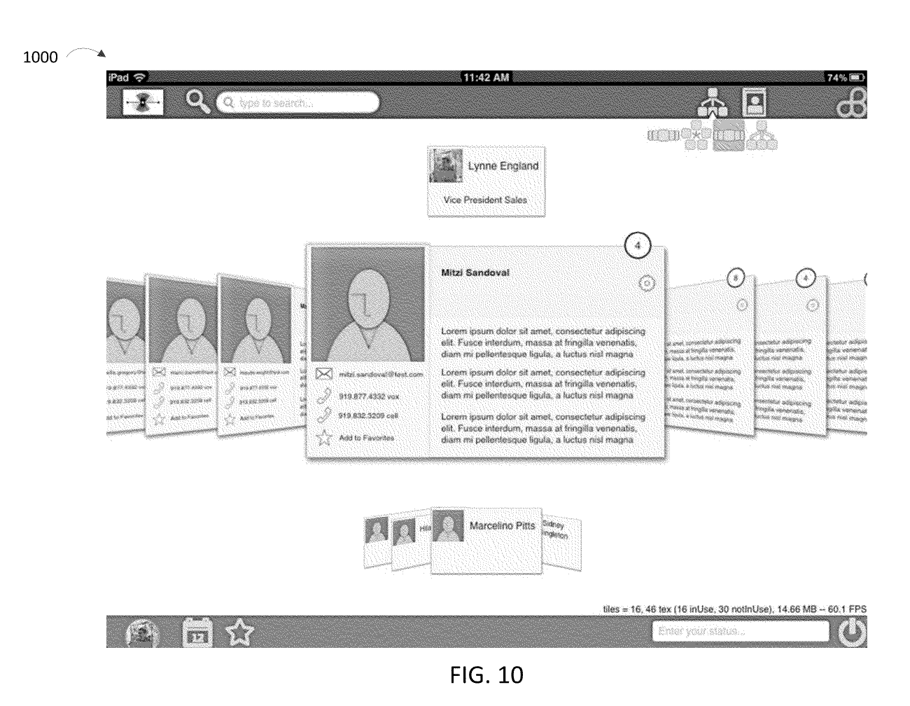

Additional cards in the organization hierarchy may be displayed in the graphical user interface. In one embodiment, a plurality of cards is shown in the same region alongside the initial active card. Each of the cards displayed in one region may be associated with the same hierarchical level and share the same superior component, for example the same superior planning component or manager. In one embodiment illustrated in FIG. 10 and further described below, an organization hierarchy is presented in a graphical user interface. A plurality of organization components may be shown in the same region, and may be associated with the same superior organization component. In some embodiments, some or all components associated with the same superior hierarchical component are associated with the same hierarchical level. As shown in FIG. 10, cards in the same hierarchical level as the active profile or active card may be shown flanking the active card on either side. In another embodiment, components associated with the same hierarchical level as the active card may be displayed in other formats.

One or more levels of an organization hierarchy may be displayed in the graphical user interface. In one illustrated embodiment, FIG. 10 displays three hierarchical levels. Multiple hierarchical levels may be arranged into different regions of a graphical user interface. In an embodiment, one or more lower level profiles may be selected to display in a lower region of the graphical user interface. The one or more second level profiles may be selected based at least in part on the initial active profile. For example, profiles having a subordinate hierarchical relationship with the initial active profile may be displayed in the lower region. In the example, such lower level profiles may be direct reports of the initial active profile.

In another embodiment, one or more upper level profiles may be selected to display in an upper region of the graphical user interface. The one or more upper level profiles may be selected based at least in part on the active profile. For example, profiles in a higher hierarchical level than the active profile in the middle region of the graphical user interface may be displayed in the upper region of the graphical user interface, directly or indirectly above the active profile.

A search interface may be provided in the graphical user interface to allow for flexible searching of the organization hierarchy. Users may be able to search anywhere within an organization hierarchy, including organizational units, individual organization members, and organization planning components.

In step 108 an update to the organization hierarchy is received. An update may comprise information associated with a new component of the organization hierarchy, such as a new employee or information associated with an existing component of the organization hierarchy, such as a new office phone number for an existing employee. Or, an update may comprise a reorganization of an organization component, such as changing an employee's manager, or re-assigning a project to a different department.

A graphical user interface may also facilitate quick and easy updates and/or modifications to the organization hierarchy. For example, an organization hierarchy may be easily reorganized in the graphical user interface by moving (e.g. pulling or dragging) an organization component, a hierarchical level, or an organizational unit to a different parent. In one embodiment, when an organization hierarchy is reorganized by moving an organization member, all subsidiary members may be moved as well.

An organization hierarchy and/or organization components may be easily reorganized through the graphical user interface by moving a component to a different parent. An employee may be selected and dragged from a first location associated with a first supervisor to a second location associated with a second supervisor. A planning component, such as an action or task, may be moved from one employee to another or a resource component such as a laptop or printer may be reallocated from one office to another.

In one embodiment, when an organization component is moved or reorganized, all organization components subsidiary to the moved component may also be moved. For example, moving a manager from one department to another may cause all of the manger's direct reports to be moved to the new department as well. In another embodiment, movements or changes to an organization component may not move or change subsidiary components. In such an embodiment, when a superior hierarchical component is moved, all of that components inferior elements may remain in the same hierarchical level with an empty or placeholder, or as one alternative, may be automatically moved up a hierarchical level.

Users may be able to create and manage new organization components, such as new groups, teams, or projects on the fly. Employees with the necessary rights, or appropriate permission level, may be able to create and manage groups. A group may have its own page in an organization hierarchy application, similar to an individual home page.

Embodiments may provide a granular security model that allows tight control of which users can view and/or edit components in the organization hierarchy.

Embodiments may also provide audit capabilities. Auditing may be used to track changes to the organization hierarchy by date, time, and user, allow administrators and other users to determine who changed what and when. Additionally, auditing may be able to track how individual and/or aggregate users view and interact with the organization hierarchy to improve the organization hierarchy application.

In step 110 the updated organization hierarchy is displayed. An updated organization hierarchy may include visual cues to alert a user that information has been recently updated. For example, a newly added phone number, or an updated office location, may be highlighted or blink for a limited duration, such as a period of seconds, minutes, hours, or days. As another example, new organization components such as projects or employees may appear in a separate and/or additional organization hierarchy view, such as a “new projects” view.

Embodiments of the invention may advantageously tie social media information to specific items in an organization hierarchy. Users may quickly and easily navigate an organization chart view of an organization hierarchy in order to find and communicate with other organization members. Member profiles may include links to communication applications such as e-mail, instant message, voice calling, video chatting, and text messaging. By integrating communication applications into an organization hierarchy application, embodiments may use web and mobile based technology to harness communication into more productive dialogues between organization members.

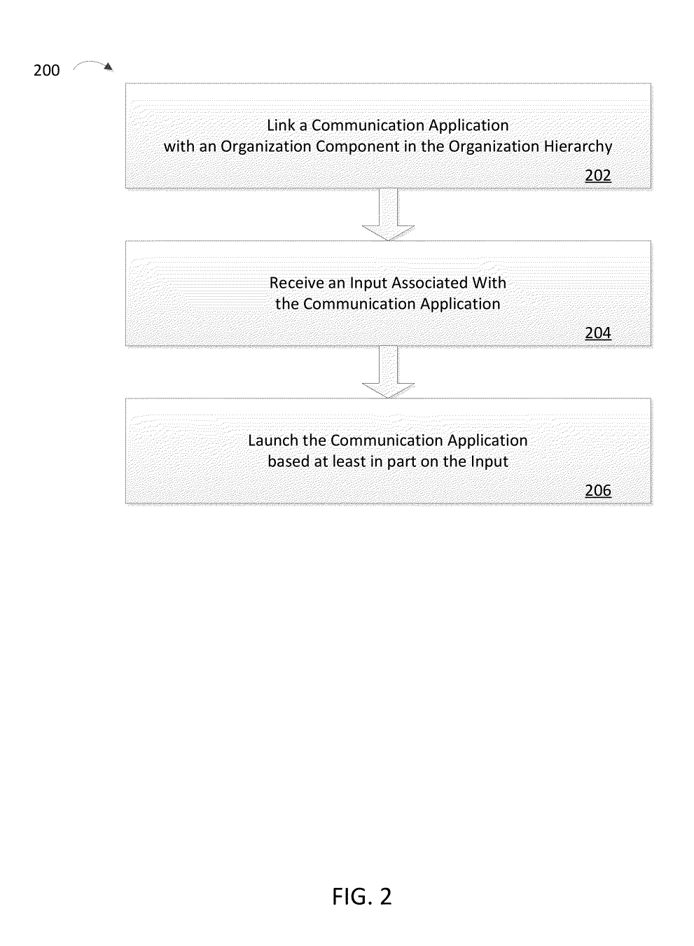

FIG. 2 is a flow chart illustrating a second method 200 for arranging and presenting information according to a strategic organization hierarchy. In step 202 a communication application is linked with an object in the organization hierarchy. The communication application may comprise, for example and without limitation, an email application, an instant message application, a VOIP application, a video chat application, or a text message application.

In one embodiment, an organization hierarchy comprises a plurality of member profiles. Each member profile may comprise contact information, such as an email address, telephone number, and/or instant message id. One or more communication applications may be linked to the contact information. For example an email communication application, such as Microsoft Outlook, may be linked with an email address of a member profile, or a video chat application, such as Skype, may be linked with an instant message address of a member profile.

In step 204, an input associated with the communication application is received. In an embodiment, a user may view a member profile comprising contact information in a graphical user interface. The graphical user interface may be displayed by a web application, or by a native device application, such as an Android phone application or an iOS iPad application. The member profile may be an object, or component, of an organization hierarchy, and may comprise contact information such as an email address, an instant message address, a VOIP address, and/or a text message address. Input associated with a communication application may comprise a selection or activation of a contact information field. As examples, a user may click on an email address, touch a phone number, or otherwise activate or select a communication field.

In step 206, the communication application is launched based at least in part on the input. In an embodiment, a user activates or selects a communication field. For example, a user clicks on a text message address or number within an organization hierarchy application. In response, the organization hierarchy application may launch a text message application. Further, the organization hierarchy application may trigger a new text message draft to be created within the text message application, including the text message address of the member profile being viewed in the organization hierarchy application.

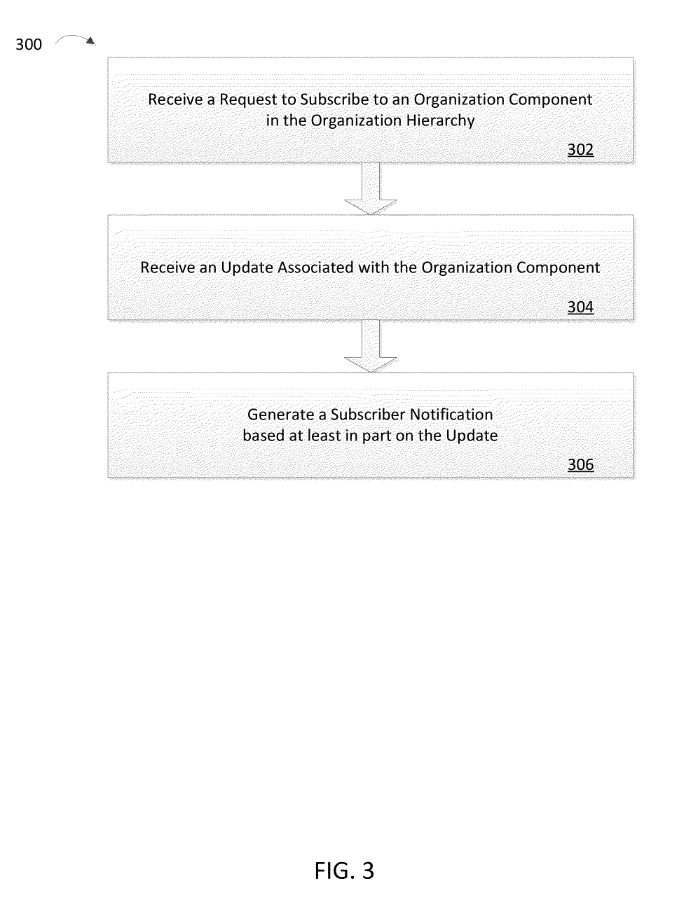

Embodiments may allow a user to subscribe to different aspects of an organization hierarchy, and have updates pushed to the user. FIG. 3 is a flow chart illustrating a third method 300 for arranging and presenting information according to a strategic organization hierarchy. In first step 302, a request is received to subscribe to an organization component in the organization hierarchy. A request, such as a subscription request, may be received from a user viewing an organization in an organization hierarchy application. For example, a user may click on a subscribe button or link on an organization member card or project.

In second step 304, an update associated with the organization component is received. An update may be received locally, for example, from a user editing an organization component from an organization hierarchy application. An update may also be received remotely, for example, from an Active Directory server. An update may comprise, for example, an updated completion percentage, a new meeting time, or a new subordinate member. An update may also comprise new information such as a post or note added to an organization component. In one example, an organization hierarchy application receives meeting notes associated with a project, included progress notes and updated completion percentage. In another example, a user adds a note to a task directly in an organization hierarchy application.

In third step 306, a subscriber notification is generated based at least in part on the update. A notification may comprise an email, text message, automated phone call, or some other type of electronic communication. A notification may also be generated within an application, such as an organization hierarchy application, with audio, visual, and/or haptic cues for alerting a user.

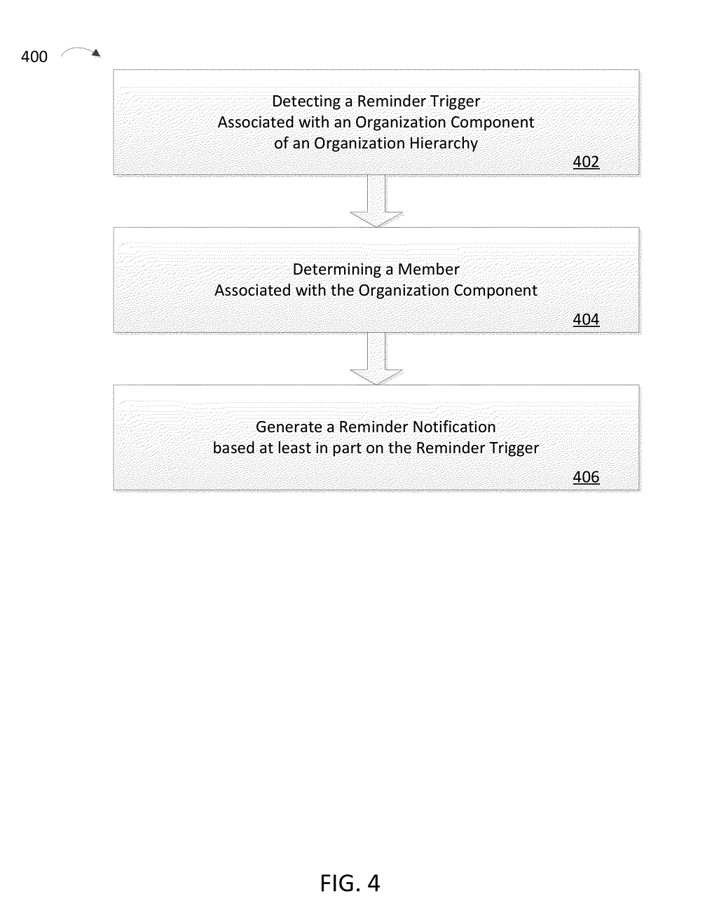

Embodiments may push a reminder to a user reminding the user to update their status and progress. FIG. 4 is a flow chart illustrating a fourth method 400 for arranging and presenting information according to a strategic organization hierarchy. In first step 402, a reminder trigger associated with an organization component of an organization hierarchy is detected. An organization component may include an automatically and/or manually generated reminder trigger. In one example, a new action may automatically include a weekly reminder trigger for updating the status and completion percentage.

In second step 404, a member associated with the organization component is determined. An organization component may be directly associated with a member. For example, a project may be associated with a project owner, or a task may be tied to a specific team member.

In third step 406, a reminder notification is generated based at least in part on the reminder trigger. A reminder notification may comprise an email, text message, automated phone call, or some other type of electronic communication. A reminder notification may also be generated within an application, such as an organization hierarchy application, with audio, visual, and/or haptic cues for alerting a user.

### Example System

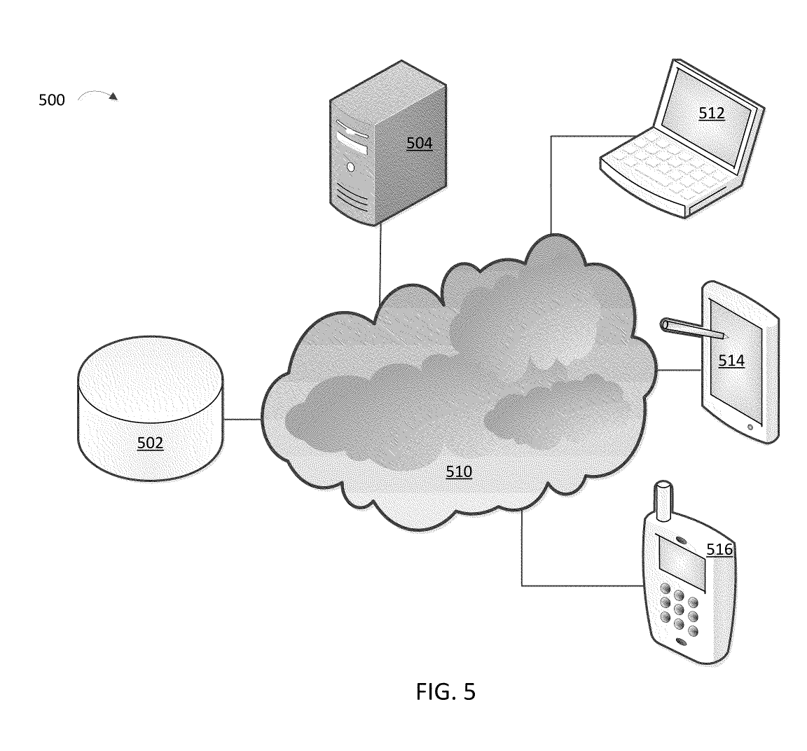

FIG. 5 is a block diagram illustrating a system 500 for arranging and presenting information according to a strategic organization hierarchy. As shown in FIG. 5, system 500 comprises data store 502, integrated services server 504, and client devices 512, 514, 516. As shown in FIG. 5, client devices 512, 514, 516 comprise personal computer 512, tablet device 514, and smart phone 516. Data store 502, integrated services server 504, personal computer 512, tablet device 514, and/or smart phone 516 may be in communication over a network 510, such as the internet or a corporate intranet.

Data store 502 may store information associated with an organization (“organization information”), and may comprise one or more databases. Data store 502 may comprise one or more directory databases, such as and without limitation, Active Directory, eDirectory, Red Hat Directory Server, Apache Directory Server, OpenDS, and OpenLDAP. Other organization data stores may comprise Microsoft Outlook, Microsoft Lync, or Microsoft Exchange Server.

Integrated services server 504 may comprise a network interface and may receive organization information over network 510. After receiving organization information, integrated services server 504 may arrange the organization information into an organizational hierarchy and determine a format for presenting some or all of the organizational information. Integrated services server 504 may receive organization information and/or updates to organization information from data store 502 and/or client devices 512, 514, 516.

The organization hierarchy may be presented in a graphical user interface generated on client devices 512, 514, 516. Personal computer 512 may comprise a workstation, laptop, tower computer, or some other type of computing device. Tablet device 514 may comprise a tablet device or electronic reader, such as an Apple iPad, Kindle Fire, or Galaxy Tab. Smart phone 516 may be an Apple iPhone, windows phone, Android phone, or some other type of mobile computer.

Client devices that present an organization hierarchy may comprise various forms of input means for viewing and navigating an organization hierarchy. Examples include touch screen displays, sensor input, and/or human interface device input (e.g. mouse, stylus).

Client devices may include touch screen interfaces, such as multi-touch displays. Alternatively, or in addition to touch-screen displays, some devices may include non-touch input enabled displays, such as LCD and/or LED monitors. Some devices may include gyroscopic sensors, cameras, GPS locationing, and other input sensors.

The integrated services server 204 may use one or more factors to determine the presentation format for viewing and navigating the organization hierarchy, such as the device that the organizational information is being displayed on. For example, if the organizational information is being presented on tablet device 214, integrated services server 204 may choose a format optimized for the display size (e.g. less than 5″) and/or specific capabilities of the device (e.g. GPS locationing, gyroscopic input).

### Example Screen Shots

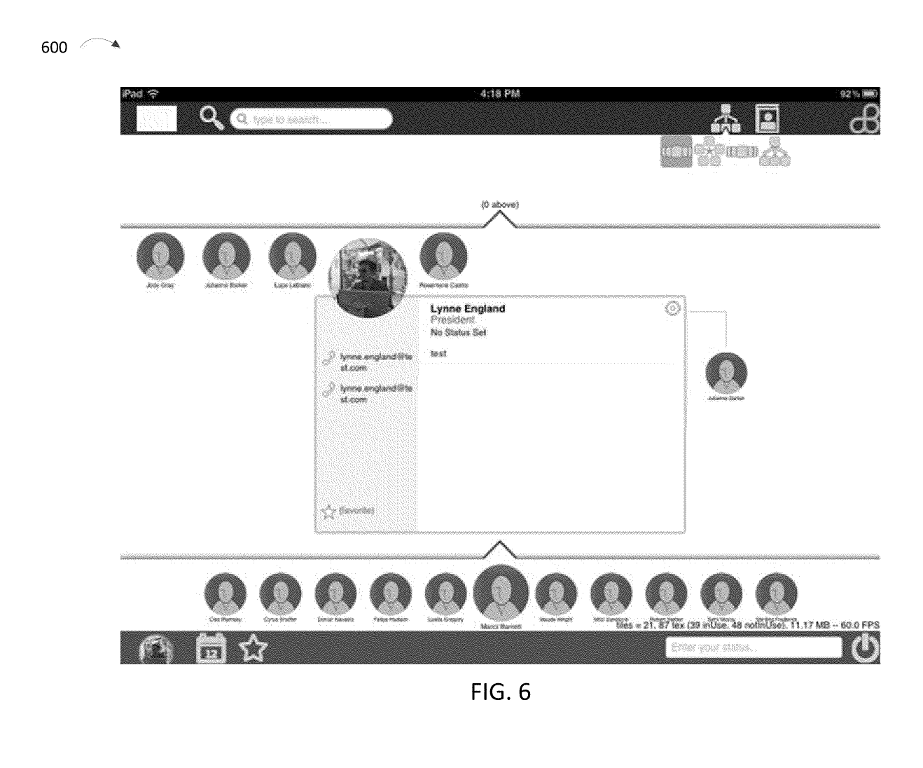

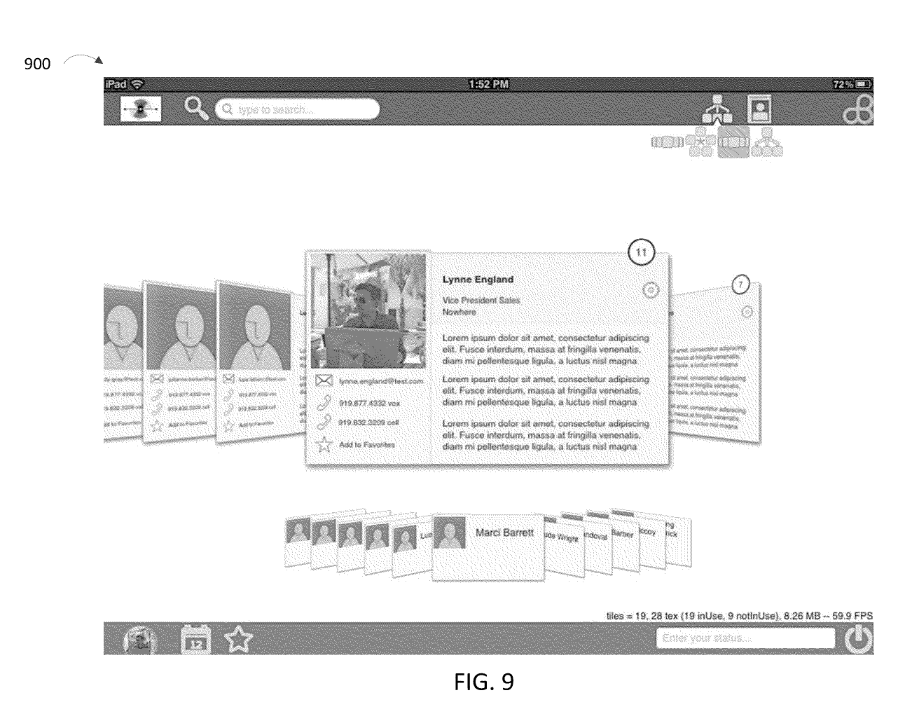

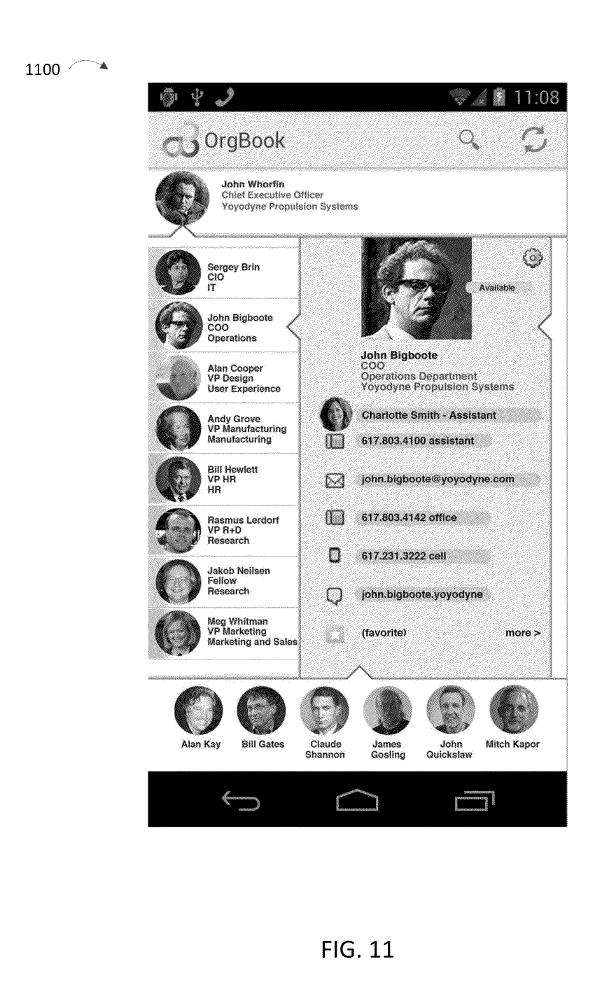

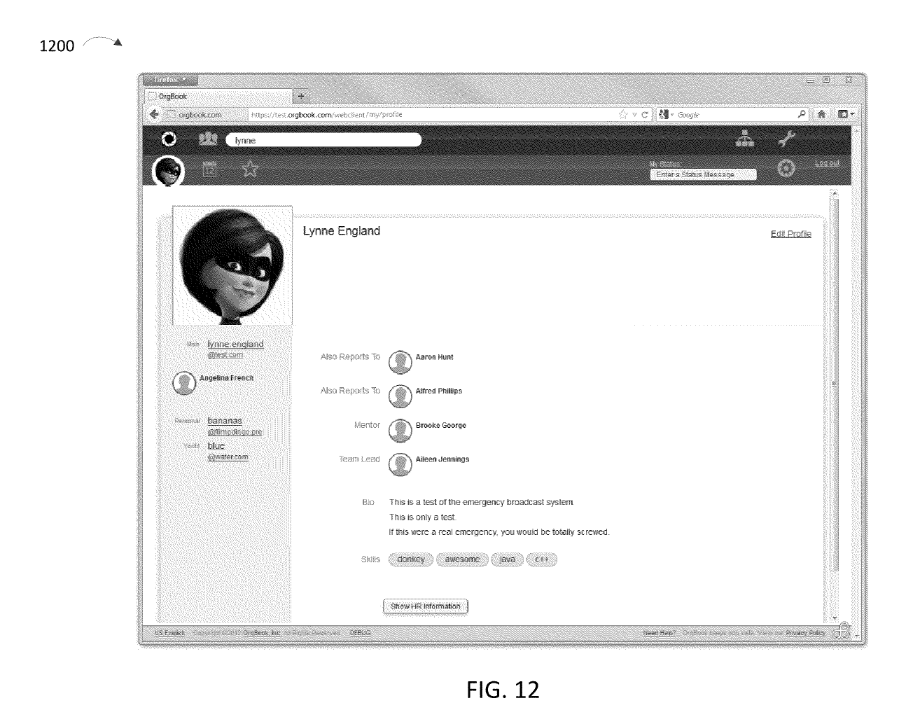

FIGS. 6-14 are screenshots illustrating multiple views of embodiments for arranging and presenting information according to a strategic organization hierarchy. As shown by the various figures, FIGS. 6-10 are screenshots of an organization hierarchy application executing as an iPad application. FIG. 11 is a screenshot of an organization hierarchy application executing as an Android application. FIGS. 12-14 are screenshots of an organization hierarchy application executing as a web application. In other embodiments, other views may be generated on various platforms, such as an iPhone, Windows Phone, or some other device.

The arrangement and presentation of an organization hierarchy may be tailored to the configuration of a particular device, such as a tablet, web browser, or phone. A tablet may afford a higher resolution display and/or a larger display size, affording the presentation of more information about the organization hierarchy than a phone display. A web interface may afford similar resolution to a tablet, but de-emphasize touch-based navigation (e.g. swiping) common to tablets, and emphasize mouse-based navigation (e.g. through scroll bars) common to desktop computers.

The number or portion of profiles shown in a region may be based on one or more factors, such as the size of the display or the position of the active profile within the hierarchical level. On a larger display, such as display for a web browser, more profiles may be displayed than on a smaller display, such as a smart phone display. In some embodiments, a hierarchical level may comprise few enough members such that all corresponding profiles may be displayed within a region. In other embodiments, a hierarchical level may comprise enough members such that only a portion of the corresponding profiles may be displayed with a region.

### iOS Application Screenshot

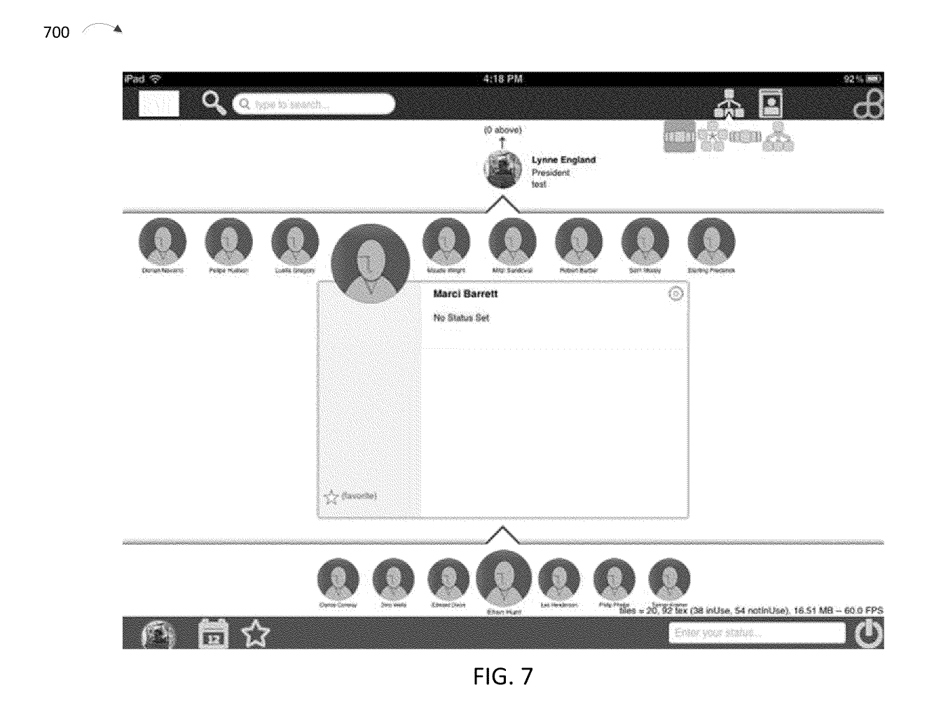

An organization hierarchy application may execute as an iOS application, such as on an iPhone or iPad tablet. FIGS. 6-10 are screenshots of an organization hierarchy application executing on an iOS iPad. One or more levels of an organization hierarchy may be simultaneously presented on the graphical user interface. In FIG. 6, two hierarchical levels may be presented, while in FIG. 7, three hierarchical levels may be presented. Users may browse or navigate between levels of an organization hierarchy through various methods, such as vertical swiping or vertical scrolling. Using FIG. 6 as an example, a user may navigate from a first hierarchical level to a second hierarchical level by vertically scrolling, or vertically swiping in the graphical user interface. As one alternative a user may select an organization component of a different hierarchical level to cause that organization component and the associated hierarchical level to scroll into a middle region.

One or more organization components of an organization hierarchy may be represented as a card in a graphical user interface. A user may browse or navigate between components of an organization hierarchy by scrolling through a succession of cards, such as in a horizontal carousel. A graphical user interface may depict a plurality of organization components and a card associated with one of the plurality of organization components. A user may navigate to a different hierarchical level component by horizontally scrolling, or horizontally swiping in the graphical user interface. As one alternative, a user may select a different hierarchical level component individually, and immediately (or nearly immediately) navigate to the selected hierarchical level component.

Within the graphical user interface, a hierarchical level of the organization may be shown in a central or middle region of the graphical user interface as the active hierarchical level. In the example, the active hierarchical level may be displayed as an alphabetically arranged carousel of profiles that correspond to individual corporate employees. One profile associated with the currently shown hierarchical level may be selected as the active profile, and be shown in an expanded view, thereby displaying more detail about that employee, such as the employee's picture, name, title, department, email address, voice number, and biography. The profiles corresponding to the other employees belonging to the same hierarchical level may be shown on either side of the active profile in a collapsed view, only depicting the employee's name and picture.

A subordinate hierarchical level, including a plurality of subordinate profiles, may be shown below the active hierarchical level in the graphical user interface. Each employee shown in the subordinate hierarchical level may have a subordinate hierarchical relationship to the employee corresponding to the active profile above. Additionally, one or more profiles may be shown above the active hierarchical level. Each employee represented above the active hierarchical level may have a superior hierarchical relationship with the employee represented by the active profile. Thus, in the example, three levels of a corporate hierarchy may be shown in the graphical user interface.

Users may navigate the organizational hierarchy by selecting, horizontally scrolling, and/or swiping among individual profiles within each hierarchical level, or through selecting, vertical scrolling, and/or swiping between different hierarchical levels. As a user navigates profiles in the active hierarchical level to select a new active profile, the subordinate hierarchical level profiles are updated to reflect employees that are subordinate to the newly selected active profile.

An empty hierarchical level may be represented as an empty graphical region. An empty hierarchical level may indicate that the active organization component is at the top or bottom of an organization hierarchy, and may not have a superior or subordinate organization component.

Organization components may be represented in the graphical user interface in various manners. In one embodiment, an organization component, such as an organization member, may be represented as a card in the graphical user interface. One or more cards may be shown at the same time. As shown in FIG. 6, a card is depicted in screenshot 600. Organization components may also be represented in other manners, for example, as a combination of text and graphical icons. As shown in FIG. 6, a plurality of organization members is represented as a combination of text and graphical icons.

Representations of organization components may display various information associated with that organization component, such as a name and department. Some information displayed about an organization component may be specific to that type of component. For example representations of organization members may display an image, (e.g. head shot, candid photo, etc.), name, title, email address, telephone number(s), office location, education, skills, certification, group memberships, experience, hiring date, and other social and strategic information. Representations of planning components, such as projects, may include a project name, start date, target date, author, project participants, status, and completion percentage.

An organization component may be presented in one or more different views. In some embodiments, an expanded view of a profile, i.e. an expanded profile, may show more information than a collapsed view of a profile, i.e. a collapsed profile. The graphical user interface shown in FIG. 6 comprises an expanded profile, and a plurality of collapsed profiles. In some embodiments, one profile is expanded, and is the active profile, while each one of the other profiles is collapsed, and each one is a non-active profile. An active card may be prominently displayed in the graphical user interface, for example, in the middle, or center, of the graphical user interface.

As shown in FIG. 6, a single card is shown, and is the active card. The active card in FIG. 6 may comprise a plurality of information about the associated organization component, such as a picture, name, title, location, biography, email address, telephone number, and number of subordinates. In other embodiments an active card may display other information about the associated member, such as that member's certifications, skills, experience, hiring date, salary, efficiency, and/or status.

Non-active cards or profiles may be collapsed, and show less information than an active profile. As shown in FIG. 6, a plurality of collapsed profiles only show the organization component's name and picture. In other embodiments, the information shown in expanded and collapsed profiles may be different.

The format and content of expanded and/or collapsed profiles may be determined based on one or more factors. In one embodiment, a user may specify which organization information to display in an expanded profile. For example, a user may configure an expanded profile view to show certain information, such as a member's education, skills, and certifications, while hiding other information, such as their department. In another embodiment, the information shown in the expanded and/or collapsed profiles may be tailored to specific users or groups. For example, users in a human resources department may view expanded profiles including information such as hiring date and salary, while users in an engineering department may view expanded profiles including experience and skills.

One or more hierarchical levels may be displayed in at least one region of the graphical user interface. In one embodiment, a first hierarchical level is displayed in first region, a second hierarchical level is displayed in second region, and a third hierarchical level is displayed in third region. For example, as shown in FIG. 7, a first hierarchical level is shown in a top region, a second hierarchical level is shown in a middle region, and a third hierarchical level is shown in lower region.

Each hierarchical level displayed in the graphical user interface may comprise one or more organization components, which may be represented as cards or profiles. As shown in FIG. 6, the active hierarchical level shown in the middle region may comprise a plurality of profiles. A subordinate hierarchical level shown in the lower region comprises a plurality of subordinate profiles. Each one of the primary profiles may be associated with an organization member that belongs to the primary hierarchical level. Each one of the subordinate profiles may be associated with an organization member that belongs to the subordinate hierarchical level.

All or a portion of the components of a hierarchical level may be displayed in a region. In one embodiment, a view of an organization hierarchy may be narrowed by some criteria, such as members actively working on a particular project.

In another embodiment, an organization hierarchy is arranged according to a vertical, bottom-up model. For example, in a representation of a bottom-up hierarchy, a hierarchy level shown in a lower region may correspond to a superior organizational level (e.g. C.E.O., president, team leader), while the hierarchy level shown in a higher adjacent region may correspond to a subordinate hierarchy level.

Organization components, and cards or profiles or organization components, may be arranged according to one or more criteria. Profiles may be arranged alphabetically, by either first or last name. Alternatively, profiles of organization components may be arranged by target date or priority.

Members belonging to a hierarchical level displayed in one region may have a hierarchical relationship with a member of a hierarchical level displayed in another region. According to FIG. 6, a subordinate hierarchical level may be displayed in a lower graphical region of the graphical user interface. Each organization component shown in the subordinate hierarchical level may have a subordinate hierarchical relationship to the active profile. For example, in an organization chart view, each member belonging to a lower hierarchical level may directly report to the member associated with active profile. As shown in FIG. 7, each organization component shown in the middle graphical region may have a subordinate hierarchical relationship with the organization component shown in the upper graphical region.

A user may navigate through each hierarchical level using keystrokes, scrolling input commands and/or gestures. For example, a user may navigate from left to right or right to left by dragging a horizontal scroll bar, through a horizontal swipe gesture, and or by using left or right arrows. A user may navigate about different hierarchical levels by scrolling up or down, vertical swiping, up and down arrows, and/or page up and page down buttons. As a hierarchical level shown in one region is navigated, hierarchical levels in other regions may be updated. As a user navigates a hierarchical level to a display a new active profile, a new list of subordinate organization components may be shown.

Users may navigate one or more hierarchical levels from the same view. In some embodiments, users may navigate a subordinate and/or superior hierarchical level while the current active profile remains fixed. As shown by screenshot 700 of FIG. 7, a user may browse a hierarchical level in one graphical region of the screen (such as a subordinate hierarchical level in a lower graphical region) with the active profile remains the same.

As a user navigates through different levels of the organizational hierarchy in the flow view format, previous selections and/or actions may be remembered by the system. For example, a user may navigate through one level of an organizational hierarchy, and arrive at a particular individual. Later, after navigating above or below several levels of the hierarchy, when the user returns to the original hierarchical level, the active profile returns to that same particular individual. Such behavior may provide continuity during use of the application as a user browses through organizational information.

According to screenshot 600, an organization hierarchy application may initialize with a view of organization components at the top level of the organization, or the highest hierarchical level. In other embodiments, an initial view may begin with the user's own profile, or the last profile that a user viewed.

Another advantage of the invention is the generation of contextual information to help users understand and digest the organizational information they are viewing. Contextual information may be ascertained based on the format and display of the organizational information. As one example, information such as the relative size of various teams or departments can be quickly ascertained by navigating through each level and viewing the number of cards displayed in each hierarchical level.

Views presented by an organization hierarchy application may have two dimensional and/or three dimensional aspects. As a user scrolls from one level to the next, a graphical animation such as a group of profiles expanding or exploding into the active level may be generated. Profiles being moved away from the active level may collapse into a single profile. Vertical scrolling through each hierarchical level of profiles may simulate the rotation of a rolodex, with profiles becoming larger as a level is scrolled to, and profiles becoming smaller as a level is scrolled away from.

One advantage of the invention is the ability to arrange and selectively present organizational information based on a variety of criteria. Different workspaces and formats can be designed to automatically match the strategic needs and individual preferences of various users. The information shown for each individual may be determined by a system administrator. As one alternative, the information shown for each individual may be customized by an individual user, or according to a rule set associated with a classification of a user. For example, individuals classified as executives within an organization may be able to view certain information about individuals, such as their salary, or efficiency rate. Such information may not be displayed to individuals classified as associates or contractors.

In one embodiment, each individual in an organization is associated with a permission level. Information displayed by the system may be determined based in part on the permission level of the active user. An executive, such as the organization's President or Chief Executive Officer, may have an executive permission level. An hourly employee, such as a contractor, may have a more limited permission level.

In some embodiments, one or more profiles displayed in the graphical user interface may be edited, annotated, saved, “favorited”, “liked”, or otherwise manipulated. In one embodiment, only an active profile may be edited. In other embodiments, multiple profiles displayed in the graphical user interface may be edited from the same view. As examples, while one profile remains the active profile, a user may be able to update an image of an inactive profile or add an inactive profile to their favorites list.

Some or all of the information shown about an organization component may be edited or updated. For example, a picture, title, status, and/or biography may be edited. In one example, a user may click on an image to access a photo upload widget. In other examples, users may be able to add qualifications, remove biographical information, or otherwise edit information shown in an organization hierarchy application. In some embodiments, some information may editable, while other information may be locked.

The field(s) that may be edited by a user may be determined based on a permission or access level associated with the user. In one embodiment, a user may be limited to updating or editing their own profile. For example, all employees may have access permissions to update their own profile. In another embodiment, a user may be able to update or edit any profile in the organization. For example, a manager may be able to update any member profile associated with members of her team.

In one embodiment, an organization component may be editable by users within the organization hierarchy application. For example, in the view shown in FIG. 6, the active card comprises an edit icon. A user may be able to click on the edit icon, and activate an edit mode, where changes can be made to information shown in the profile.

Users may also be able to add their own notes or comments to a profile. For example, a user may add a reminder to email a team leader with a status report at the end of the week. Such a note may be synchronized with other software, such that a calendar reminder is automatically added for the user, and/or a task list is automatically updated.

An organization component shown in an organization hierarchy application may comprise one or more widgets, such as a favorite widget. In the view shown in FIG. 6, the active profile comprises a Favorites widget. A user may click on the Favorites icon (depicted as a star in FIG. 6) and/or “Add to Favorite” text and thereby add active profile to a list of saved, or favorite organization components. A favorites list may include one or more organization components available for quickly viewing in a separate interface.

### Android Application Screenshot

An organization hierarchy application may execute as an Android application, such as on an Android phone or Android tablet. FIG. 11 depicts an organization hierarchy application executing on an Android phone.

As shown by screenshot 1100 of FIG. 11, an organization hierarchy may depict a plurality of organization hierarchy components in different graphical regions of a graphical user interface. An upper graphical region of screenshot 1100 may depict a superior hierarchical component associated with a hierarchical level superior to, or above the active hierarchical level associated with an active organization component.

As shown in FIG. 11, a plurality of organization components may be displayed in a middle graphical region. Some organization components may be displayed in a compact or collapsed view that only shows limited details. For example, the graphical user interface may display a collapsed profile or an organization member showing only their picture, name, title, and department. In other embodiments, other information may be shown in a collapsed view of an organization component.

An organization hierarchy may be navigated through standard touch-screen gestures. For example a user may swipe upwards to display a lower (possibly subordinate) hierarchical level and/or organization components belonging to a lower hierarchical level. Visual cues, such as arrows or other icons, may indicate that additional information about an organization hierarchy and/or specific organization components may be accessed and displayed through navigation-type user actions.

### Web Application Screenshots

An organization hierarchy application may execute as a web application, and generate a graphical user interface in a modern browser, such as Google Chrome, Mozilla Firefox, and/or Safari. FIGS. 12-14 depict an organization hierarchy application executing in a web browser.

As shown by screenshot 1200 of FIG. 12, the organization hierarchy application may generate a plurality of perspectives of a data set. A profile view associated with a personal perspective may be illustrated in FIG. 12. The profile view may show some or all of the elements of an organization component, such as an organization member. In other embodiments, a profile view may show some or all elements of a different type of organization component, such as a project or task.

A profile view may comprise an interface that may define how an organization component, such as a member, is viewed by others in the organization hierarchy application. A profile view may be accessed in an organization hierarchy application, for example, by clicking or selecting a particular organization component in an Organization Chart view (e.g. Card view, radial view) or some other view, such as a recents view or favorites view, for example. A profile view may comprise one or more widgets that can be personalized, or customized, within the constraints of a defined template. The profile view may display one or more elements of an organization component, such as a picture (e.g. employee photo, personal photo, office location photo, office location floormap), title, position, project list, project roles, links to associated organization components (e.g. projects, tasks, departments, etc.), contact information (e.g. phone number, email, etc.), skills, education, certifications, work history, personal interests, posts, task list (e.g. to-do list), and/or subscriptions.

A personal perspective may comprise other views, such as a recents view and/or a favorites view. A recents view may utilize data associated with the activities of a user, such as communications and work product, to generate and display a list of recent contacts, recent documents, and/or recent meetings. A favorites view may depict organization components, such as other organization members, objectives, or tasks that have been selected by a user as a favorite. A favorites view may also include organization components that have been automatically selected as a favorite, for example, based on the activities of a user. For example, a favorites view may comprise a member automatically selected based on the frequency that a user views and/or communicates with that member.

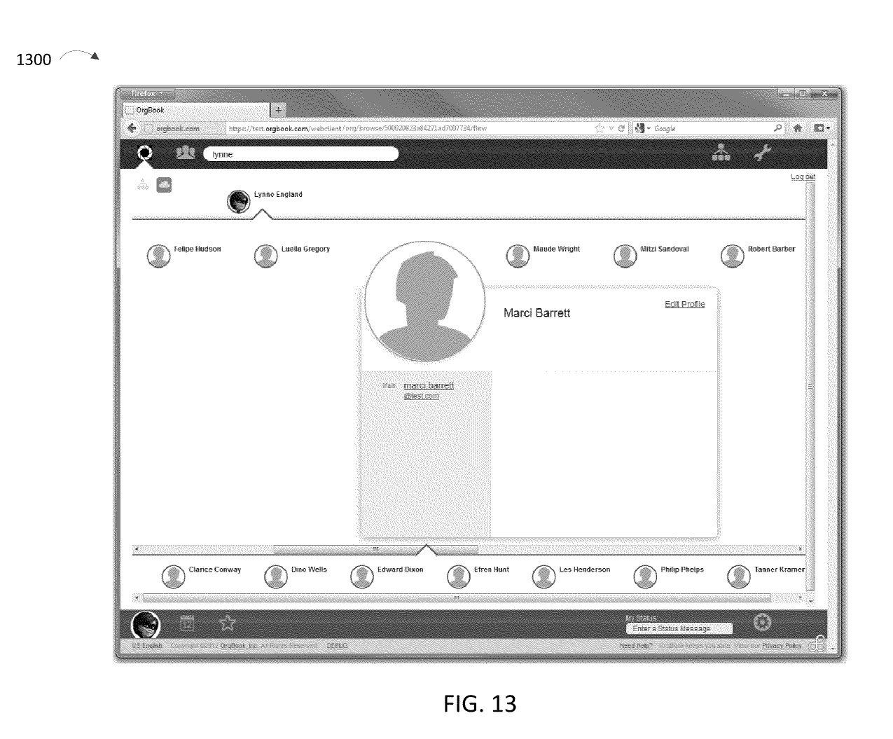

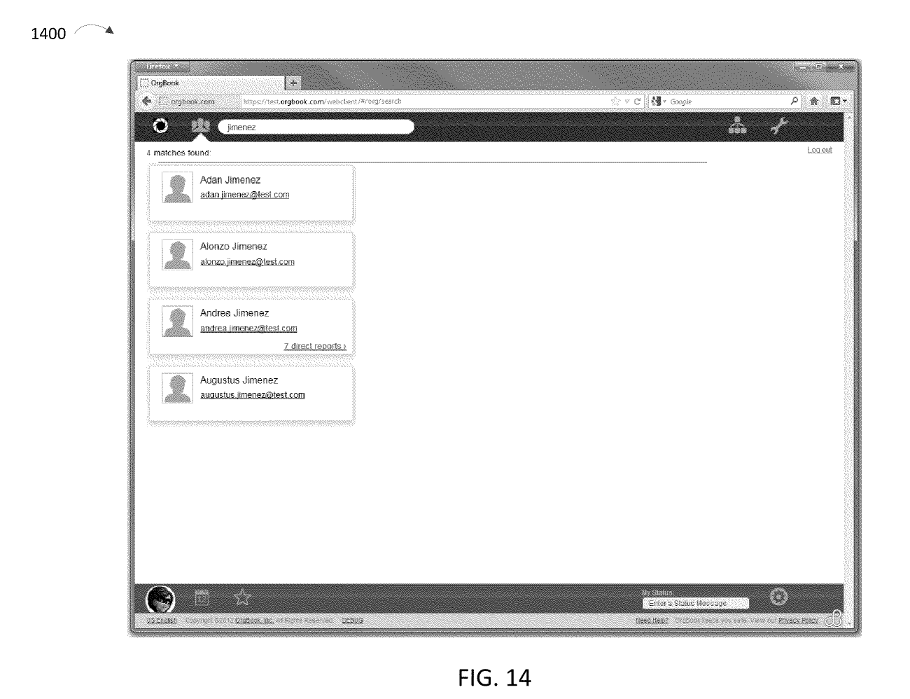

An organization hierarchy application may comprise other perspectives. FIGS. 13-14 depict an organization perspective of an organization hierarchy data set. Screenshot 1300 of FIG. 13 depicts a card view of an organization hierarchy. A card view may display one or more cards associated with organization components. As shown in FIG. 13, a card associated with an organization member is generated in the graphical user interface. The card view may display a plurality of organization components associated with one or more hierarchical levels. FIG. 13 depicts organization members belonging to the present hierarchical level (i.e. the hierarchy level of the actively displayed card) along with subordinate organization members associated with a lower hierarchical level, and a superior organization member associated with a higher hierarchical level.

Embodiments may provide extensive search capabilities that make it easy to find an organization component, such as an employee, with particular elements, such as skills or projects with particular action items. Screenshot 1400 of FIG. 14 depicts a search view of an organization hierarchy. A search view may comprise a search box that defaults to searching an entire organization hierarchy. Search operators may be accepted in the search box to narrow a search, such as to particular terms and/or particular organization components. More specific search capabilities may be provided, such as the ability to limit a search to certain organization components, or elements of organization components, such as people, organizational units, objectives, projects, groups, topics, work items, etc.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium s on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described in the following claims.

What is claimed is:

1. A method for arranging and presenting information according to a strategic organization hierarchy in a graphical user interface, the method comprising the steps of:
receiving organization information comprising a plurality of organization components;
arranging the organization information into an organization hierarchy;
displaying at least a portion of the organization hierarchy in a graphical user interface.

2. The method of claim 1, further comprising:
analyzing the organization information to determine a need for supplemental organization information.

3. The method of claim 1, wherein the organization information is associated with an organization and wherein the organization hierarchy models a structure of the organization.

4. The method of claim 1, wherein an organization component comprises an organization member, an organizational unit, a project, a goal, an objective, a strategy, a plan, or an action.

5. The method of claim 2, wherein the organization information comprises a plurality of organization components and further comprising:
determining at least one hierarchical link for each of the plurality of organization components.

6. The method of claim 4, wherein a hierarchical link comprises a superior hierarchical link or an inferior hierarchical link.

7. The method of claim 4, wherein an organization component comprises an organization member, an organizational unit, an organization goal, an organization objective, an organization strategy, an organization plan, or an organization action.

8. The method of claim 1, wherein the organization hierarchy comprises a plurality of hierarchical levels.

9. The method of claim 1, wherein the display of the organization hierarchy is based at least in part on a permission level of a user.

10. The method of claim 1, further comprising:
linking a communication application with an organization component in the organization hierarchy;
receiving an input associated with the communication application;
launching the communication application based at least in part on the input.

11. The method of claim 10, wherein the communication application comprises a social media communication application.

12. The method of claim 10, wherein the communication application is linked to an organization member.

13. The method of claim 1, further comprising:
receiving a request to subscribe to an object in the organization hierarchy;
receiving an update associated with the object;
generating a subscriber notification based at least in part on the update.

14. The method of claim 8, further comprising:
displaying a first hierarchical level of the plurality of hierarchical levels;
receiving an input associated with a second hierarchical level of the plurality of hierarchical levels;
displaying the second hierarchical level.

15. The method of claim 1, further comprising:
detecting a reminder trigger associated with an object in the organization hierarchy;
generating a reminder notification based at least in part on the reminder trigger.

16. The method of claim 15, further comprising:
determining a member of an organization to receive the reminder notification;
transmitting the reminder notification to the one or more members.

17. The method of claim 15, wherein the reminder notification comprises at least one of a reminder to update a status or a reminder to update a progress.

18. A computer program product stored in a non-transitory computer-readable medium, the computer program product comprising computer program code which, when executed, configures a computer to:
receive organizing information comprising a plurality of organization components;
arrange the organization information into an organization hierarchy;
display at least a portion of the organization hierarchy in a graphical user interface.
